SEQUENCE LISTING (2 sequences)

SEQ ID NO: 1 - DNA, 25 bp, Artificial Sequence
  quality control QC oligonucleotide
ttccagggcgcgagttgatagctgg

SEQ ID NO: 2 - DNA, 25 bp, Artificial Sequence
  probe material
ccagctatcaactcgcgccctggaa

(19) United States
(12) Patent Application Publication
(10) Pub. No.: US 2010/0167955 A1
(43) Pub. Date: Jul. 1, 2010

(54) MICROARRAY INCLUDING LAYER COMPRISING DNA MOLECULE AND METHOD OF MANUFACTURING THE SAME

(75) Inventor: Sun-ok Jung, Suwon-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/510,625

(22) Filed: Jul. 28, 2009

(30) Foreign Application Priority Data
Dec. 26, 2008 (KR) 10-2008-0134972

(51) Int. Cl. C40B 40/08; C40B 50/14

(52) U.S. Cl. 506/17; 506/30

(57) ABSTRACT

A microarray with excellent sensitivity for detecting target materials during biological assays, and a method of manufacturing the same.

### CROSS-REFERENCE TO RELATED APPLICATIONS

This application claims priority to Korean Patent Application No. 10-2008-0134972, filed on Dec. 26, 2008, and all the benefits accruing therefrom under 35 U.S.C. §119, the contents of which in their entirety are herein incorporated by reference.

### BACKGROUND

1. Field

Disclosed herein is a microarray including a layer including DNA molecules and a method of manufacturing the same.

2. Description of the Related Art

A microarray refers to a high-density array of molecules immobilized in predetermined regions of a substrate. Microarrays may be used to perform various biological, chemical, or biochemical tests. One way in which a microarray can be classified is based on the molecule immobilized on the substrate, e.g., a nucleic acid microarray, a protein microarray, etc. In nucleic acid microarrays, target nucleic acids are densely immobilized at specified regions (spots) on a substrate. Probe nucleic acids marked with a detectable marker, for example, fluorophore, and having a sequence complementary to the target nucleic acids are added to the microarray for hybridization. Following hybridization of the probe nucleic acids with the immobilized target nucleic acids, unhybridized target materials and probe materials are removed by washing. Hybridization is determined by irradiating the fluorophore of the hybridized materials with excitation light, and measuring the fluorescence emission using a detection system of a microarray scanning system.

Since a tiny amount of a sample and a reagent is used in analyses of samples using microarrays, hybridization of the probe with a target material to be detected needs to be precisely measured. However, noise signals (i.e., background signals) may be frequently detected from portions of the surface of the microarrays other than where the spot region is formed due to reasons other than the binding of the target material to the probe material. Therefore, there is a need to develop a microarray having improved sensitivity for detecting target materials during biological assays and which excludes or reduces the background noise signals to perform precise assays.

### SUMMARY

Disclose herein is a microarray with excellent detection sensitivity for analysis of target materials.

Disclosed herein is also a method of manufacturing a microarray with excellent detection sensitivity for analysis of target materials.

Additional aspects will be set forth in part in the description which follows and, in part, will be apparent from the description, or may be learned by practice of the exemplary embodiments.

To achieve the above and other aspects, an embodiment may include a microarray including: a substrate; a spot region formed on the substrate and including a probe material capable of binding to a target material; and a layer formed on a region of the substrate other than where the spot region is formed and including DNA molecules, each including at least two nucleotides.

To achieve the above and other aspects, an embodiment may include a microarray including: a substrate; a layer formed on the substrate and including DNA molecules, each including at least two nucleotides; and a spot region formed on the layer and including a probe material capable of binding to a target material.

To achieve the above and other aspects, an embodiment may include a method of manufacturing a microarray, the method including: preparing a substrate; forming a spot region including a probe material capable of binding to a target material on the substrate; and forming a layer including DNA molecules, each including at least two nucleotides, on a region of the substrate other than where the spot region is formed.

To achieve the above and other aspects, an embodiment may include a method of manufacturing a microarray, the method including: preparing a substrate; forming a layer including DNA molecules, each including at least two nucleotides, on the substrate; and forming a spot region including a probe material capable of binding to a target material on the layer.

### BRIEF DESCRIPTION OF THE DRAWINGS

The above and other aspects, advantages and features of the disclosure will become more apparent and more readily appreciated from the following description of exemplary embodiments, taken in conjunction with the accompanying drawings of which:

FIG. 1 is a schematic diagram illustrating an exemplary embodiment of microarray including: a spot region including a probe material and formed on a substrate; and a layer including DNA molecules formed in a region of the substrate other than where the spot region is formed;

FIG. 2 is a schematic diagram illustrating an exemplary embodiment of a microarray including: a layer including DNA molecules formed on a substrate and a spot region including a probe material and formed on the layer;

FIG. 3 is a graph illustrating the degree of hybridization according to the number of nucleotides contained in DNA molecules;

FIG. 4 is an image illustrating fluorescence emission measured by contacting a microarray including a spot region and a layer including hexa-ethylene glycol with a target material; and

FIG. 5 is an image illustrating fluorescence emission measured by contacting a microarray including a spot region, a layer including hexa-ethylene glycol, and a layer including DNA molecules, each including 6 nucleotides, with a target material.

### DETAILED DESCRIPTION

The disclosure now will be described more fully hereinafter with reference to the accompanying drawings, in which embodiments of the disclosure are shown. This disclosure may, however, be embodied in many different forms and should not be construed as limited to the embodiments set forth herein. Rather, these embodiments are provided so that this disclosure will be thorough and complete, and will fully convey the scope of the disclosure to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings herein.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. Thus, for example, reference to “a probe” includes a plurality of probes. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Various exemplary embodiments are described herein with reference to cross section illustrations that are schematic illustrations of idealized embodiments of the invention. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the exemplary embodiments.

Hereinafter, exemplary embodiments will be described in detail with reference to the accompanying drawings. However, the aspects, features, and advantages of the invention are not restricted to the ones set forth herein. The above and other aspects, features and advantages of the disclosure will become more apparent to one of ordinary skill in the art to which the disclosure pertains by referencing a detailed description of the exemplary embodiments given below.

In one embodiment a microarray including: a substrate; a spot region formed on the substrate, wherein the spot region comprises a probe material capable of binding to a target material; and a layer formed on a region of the substrate other than where the spot region is formed, wherein the layer comprises DNA molecules, each including at least two nucleotides.

The microarray includes a substrate. The substrate may be formed of a material capable of binding to a probe material which may bind to a target material, for example, a material selected from a group consisting of silicon, glass, metal, plastic, and ceramic. In particular, the substrate may be formed of a material selected from a group consisting of silicon, glass, gold, silver, copper, platinum, polystyrene, polymethyl acrylate, polycarbonate, and ceramic. If the substrate is formed of silicon, a silicon dioxide (SiO2) layer may be formed on the substrate so that the probe material binds to the substrate. The surface of the substrate may be treated with a material, selected from a group consisting of, but not limited to, a linker, an amine group, a carboxyl group, an epoxy group, a sulfur group, an aldehyde group, activated ester, maleimide, and carbohydrate in order to bind to the probe material contained in the spot region and the DNA molecules contained in the layer. The substrate may be in the form of a plane, a bead, or a sphere, but is not limited thereto.

In one aspect, the microarray includes a spot region formed on the substrate. The spot region comprises a probe material capable of binding to a target material.

In one aspect, the microarray includes a layer formed on a region of the substrate. The layer comprises DNA molecules, each including at least two nucleotides.

The target material may be any biomaterial to be detected using the microarray. “Biomaterial” refers to types of molecules or materials generally derivable from living organisms, or analogues thereof. Biomolecules include, e.g. amino acids, oligopeptides, polypeptides, glycoproteins, nucleotide monomers, oligonucleotides, polynucleotides, saccharides, polysaccharides, hormones, growth factors, peptidoglycans, or the like. In an embodiment, the biomaterial may be nucleic acid (e.g. DNA, RNA, nucleotide monomers, oligonucleotides, and polynucleotides), protein (e.g., amino acids, oligopeptides, polypeptides, and glycoproteins), sugar (e.g., saccharides), peptidoglycans, virus, cell, and cell organelles, but is not limited thereto. The biomaterial may include a material derived from living organisms or a synthetic or semi-synthetic material.

The target material may be labeled with a detectable labeling material. For example, the labeling material may be a fluorescent material, a phosphorescent material, or a radioactive material, but the target material is not limited thereto. The target material may be detected using various known methods such as an optical analysis method. For example, a fluorophore (a fluorescent material) may be used in the optical analysis. The fluorophore may be one selected from a group consisting of rhodamine 200, calcium green, cyanine 2, cyanine 3, cyanine 5, magnesium green, tetrametylrhodamine, and Fluorescein, but is not limited thereto. In particular, the existence and the amount of the target material may be detected by adding a sample including a target material bound to the fluorophore to a microarray bound to the probe material, removing target materials which do not bind to the probe material, and detecting signals generated from the fluorophore bound to the target material bound to the probe material using an optical method.

The probe material is a material capable of binding to the target material. The probe material may include a single biomaterial monomer or a plurality of biomaterial monomers. The biomaterial may be selected from a group consisting of DNA, RNA, nucleotide, nucleoside, protein, polypeptide, peptide, amino acid, carbohydrate, enzyme, antibody, antigen, receptor, virus, substrate, ligand, membrane, and any combinations thereof, but is not limited thereto. Thus, the microarray according to an embodiment may include a probe material selected from a group consisting of DNA, RNA, nucleotide, nucleoside, protein, polypeptide, peptide, amino acid, carbohydrate, enzyme, antibody, antigen, receptor, virus, substrate, ligand, membrane, and the like, and a combination comprising at least one of the foregoing probe materials. The biomaterial monomer may be a nucleoside, nucleotide, amino acid, or peptide according to the type of the probe material bound to the surface of the substrate, but is not limited thereto. The nucleoside and nucleotide may include purine and pyrimidine bases, methylated purine or pyrimidine, or acylated purine or pyrimidine. In addition, the nucleoside and nucleotide may include ribose sugar, dioxyribose sugar, or a modified sugar in which at least one hydroxyl group is substituted with a halogen atom or an aliphatic compound or to which a functional group such as ether and amine is bound. The amino acid may be natural amino acid such as L-, D-, and nonchiral amino acid, a modified amino acid, or an amino acid analog, but is not limited thereto. The peptide may be a compound formed by amide bonds between a carboxyl group of one amino acid and an amino group of another amino acid. The probe material may bind to the substrate of the microarray and/or the layer, as defined herein, directly or via a linker. The spot region includes at least one probe material, and at least two spot regions may be formed on the substrate of the microarray and/or the layer. According to the purposes of the microarray, the spot region may include the same or different probe materials.

In an embodiment, a microarray comprises a substrate; a layer formed on the substrate, wherein the layer comprises DNA molecules, each comprising at least two nucleotides; and a spot region formed on the layer, wherein the spot region comprises a probe material capable of binding to a target material. The spot region including a probe material may be formed on the layer formed on the substrate. In this regard, the layer may be formed on the substrate, and the DNA molecules contained in the layer may bind to the probe material contained in the spot region. Thus, if the spot region is formed on the substrate, the probe material may bind to the substrate. If the spot region is formed on the layer, the probe material may bind to the DNA molecules of the layer.

Thus, in one aspect, the microarray includes a spot region formed on the layer. The spot region comprises a probe material capable of binding to a target material.

In one aspect, the microarray includes a layer formed on a region of the substrate. In another aspect, the microarray includes a layer formed in a region of the substrate other than where the spot region is formed. The layer comprises DNA molecules, each including at least two nucleotides.

The layer may include DNA molecules, each including at least two nucleotides, or the DNA molecules and other materials used to immobilize the DNA molecules. The DNA molecule may include at least two nucleotides. The DNA molecule may be a single-stranded molecule. The DNA molecule may include at least two nucleotides including a base selected from a group consisting of adenine, guanine, thymine, and cytosine. For example, the DNA molecule may include at least two nucleotides including a base randomly selected from a group consisting of adenine, guanine, thymine, and cytosine.

In one aspect, the DNA molecule may include 2 to 6 nucleotides. The DNA molecule may bind to a complementary DNA molecule or another biomaterial at a particular temperature. For example, a DNA molecule including 2 to 6 nucleotides may be hybridized with a DNA target material having a base sequence complementary to a base sequence of the nucleotides contained in the DNA molecule at a temperature equal to or less than about 19° C. In contrast, if the structure of the DNA molecule including 2 to 6 nucleotides is changed, i.e., the DNA molecule does not bind to a complementary DNA molecule or another biomaterial, at a temperature greater than about 19° C., e.g., at room temperature. Thus, the DNA molecule may not bind to another DNA molecule or another biomaterial, or may undetectably bind to them.

In addition, since the DNA molecule including 2 to 6 nucleotides is also a biomaterial like the target material, the probe material, and another reagent, physical, chemical, biological, and/or biochemical reactions other than the bindings between the target material and the probe material may be inhibited by controlling biological and/or biochemical reaction conditions in a biocompatible manner in assays using a microarray. Thus, in a biological assay, the binding between the probe material contained in the spot region and the target material may be promoted by the layer including DNA molecules, each including 2 to 6 nucleotides, at a temperature greater than about 19° C.

The layer including DNA molecules or the spot region including a probe material may be formed on the substrate using known methods. According to one of the methods, a predefined region of a substrate is activated, and the substrate is subjected to contact a solution including a biomaterial monomer. The predefined region may be activated by a light source, and regions other than the predefined region may be blocked from the light source using a photomask and thus are inactivated. In addition, the substrate may be selectively treated with a material having a functional group capable of binding to the biomaterial. The functional group may be an amine group, a carboxyl group, an epoxy group, or a sulfur group, but is not limited thereto. The material having the functional group capable of binding to the biomaterial may be gamma-aminopropyltriethoxysilane (GAPS), but is not limited thereto. As described above, when the spot region and/or the layer are formed by immobilizing a biomaterial such as the probe material and/or a DNA molecule on the substrate, adsorption, or physical or chemical interaction may occur between the substrate and the immobilized biomaterial. The interaction may support, promote, or catalyze the formation of the microarray. In addition, a protein may be immobilized on the substrate using carboxymethyl-dextran or avidin-biotin bindings. In addition, the surface of the substrate may be pretreated with a chemical material using polylysine or calixcrown or bound to a plurality of non-specific proteins. In addition, a linker may be used to immobilize antibody, virus, or cell on the substrate.

The layer including DNA molecules may be formed on a region of the substrate other than where the spot region is formed. For example, if the probe material binds to a region defined on the substrate to form the spot region, the DNA molecules may bind to a region of the substrate other than where the spot region is formed to form a layer. In this regard, the order of forming the spot region and the layer is not limited thereto. In addition, if the DNA molecules bind to the substrate to form a layer, the probe material may bind to the DNA molecules contained in the layer formed on the substrate directly or via a linker. In this regard, the DNA molecules contained in the layer may function as a linker between the probe material contained in the spot region and the substrate.

In an embodiment, a method of manufacturing a microarray, the method including: preparing a substrate; forming a spot region on the substrate, wherein the spot region includes a probe material capable of binding to a target material; and forming a layer on a region of the substrate other than where the spot region is formed, wherein the layer includes DNA molecules, each including at least two nucleotides.

The method includes preparing a substrate. The substrate is described above.

In an aspect, the method includes forming a spot region including a probe material capable of binding to a target material on the substrate. The target material and the probe material are described above.

In another embodiment, the method includes forming a layer on a region of the substrate other than where the spot region is formed. The layer comprising DNA molecules, each including at least two nucleotides, is described above.

The layer including DNA molecules, each including at least two nucleotides, may be formed on the substrate. The spot region including a probe material capable of binding to the target material may be formed on the substrate or the layer using known methods. For example, a microarray including the layer, the layer comprising DNA molecules, each including at least 2 nucleotides, and the spot region, the spot region comprising a probe material may be prepared by binding a nucleotide, to which a photoeliminating protection group is attached, to a substrate, removing the protection group by exposing to light using a photomask, coupling the nucleotide and another nucleotide, and repeating these processes. In addition, a microarray including the layer, the layer comprising DNA molecules, each including at least 2 nucleotides, and the spot region, the spot region comprising a probe material may also be prepared by preparing a substrate in which a solidifying agent is coated on the front surface of a slide glass, spotting droplets including prefabricated DNA molecules or probe materials on the substrate, and drying the spots.

The substrate may be in the form of a plane, a bead, or a sphere.

The substrate may be formed of one selected from a group consisting of silicon, glass, metal, plastic, and ceramic.

The nucleotide may include a base selected from a group consisting of adenine, guanine, thymine, and cytosine.

The nucleotide may comprise about 2 to about 6 nucleotides.

The probe material may be one selected from a group consisting of DNA, RNA, nucleotide, nucleoside, protein, polypeptide, peptide, amino acid, carbohydrate, enzyme, antibody, antigen, receptor, virus, substrate, ligand, membrane, and the like and any combinations thereof.

The spot region may be formed after the layer is formed, wherein the spot region is formed on the layer. In the operation of forming the layer including DNA molecules, each including at least two nucleotides, on the substrate, the layer may be formed on a portion or the entire surface of the substrate. If the layer is formed on the entire surface of the substrate, the spot region including a probe material may be formed on the layer and the probe material may bind to the DNA molecules contained in the layer. If the layer is formed on a portion of the substrate, the layer may be formed on a region of the substrate other than where the spot region is formed. Thus, if the spot region is formed before forming the layer, the layer may be formed on a region of the substrate other than where the spot region is formed. If the spot region is formed after forming the layer, the spot region may be formed on the layer.

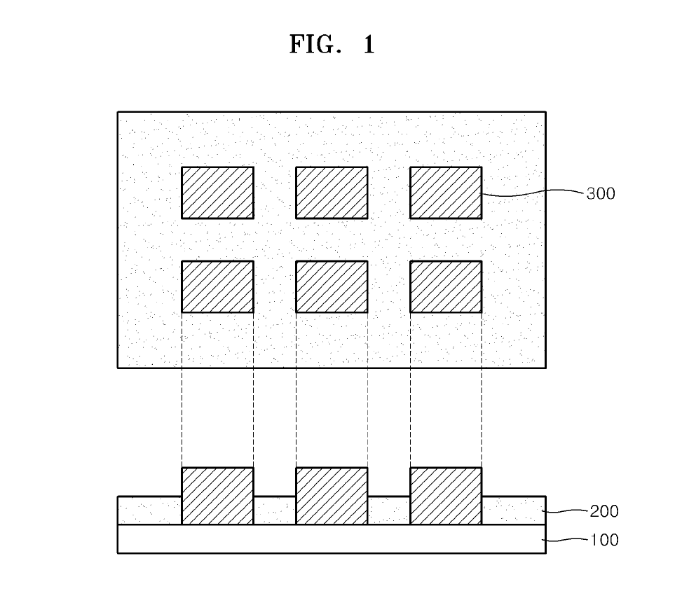

FIG. 1 is a schematic diagram illustrating an exemplary embodiment of a microarray including: a spot region 300, wherein the spot region includes a probe material and formed on a substrate 100; and a layer 200, wherein the layer includes DNA molecules formed in a region of the substrate 100 other than where the spot region 300 is formed.

Referring to FIG. 1, a probe material capable of binding to a target material is immobilized on the surface of the substrate 100, forming spot region 300. A plurality of spot regions 300 may be formed on the surface of the substrate 100 in various arrangements according to the purposes of the microarray. The spot region 300 may include various types of probe materials which may bind to a target material. For example, the probe material may be one selected from a group consisting of DNA, RNA, nucleotide, nucleoside, protein, polypeptide, peptide, amino acid, carbohydrate, enzyme, antibody, antigen, receptor, virus, substrate, ligand, membrane, and the like and combinations thereof. The probe material may bind to the substrate 100 directly or using a linker. The target material may be a biomaterial to be detected using a microarray according to an embodiment. The probe material may be a material capable of binding to the target material. For example, if the target material to be detected is a single-stranded DNA having a particular sequence, the probe material may be a single-stranded DNA having a sequence complementary to the target material. If the target material to be detected is an antigen having a three-dimensional structure, the probe material may be an antibody capable of binding to the antigen.

Referring to FIG. 1, DNA molecules, each including at least two nucleotides are immobilized on the substrate forming the layer 200 In one aspect, the layer is formed on a region of the substrate 100 other than where the spot region 300 is formed. Thus, if the spot region 300 including a probe material is formed on a region of the substrate 100 defined as above, the layer 200 including DNA molecules may be formed on a region of the substrate 100 other than where the spot region 300 is formed. Each of the DNA molecules may include at least 2 nucleotides. In this regard, each of the DNA molecules may include at least two nucleotides including a base selected from a group consisting of adenine, guanine, thymine, and cytosine. The DNA molecules may be single-stranded molecules.

Each of the DNA molecules may include 2 to 6 nucleotides. The DNA molecules may bind to complementary DNA molecules or another biomaterial at a particular temperature. For example, the DNA molecules including 2 to 6 nucleotides may be hybridized with a DNA target material having a base sequence complementary to a base sequence of the nucleotides contained in the DNA molecules at a temperature equal to or less than about 19° C. In contrast, if the structure of the DNA molecule including 2 to 6 nucleotides is changed, i.e., the DNA molecule does not bind to a complementary DNA molecule or another biomaterial, at a temperature greater than about 19° C., e.g., at room temperature. Thus, the DNA molecule may not bind to another DNA molecule or another biomaterial, or may undetectably bind to them.

In addition, since the DNA molecules including 2 to 6 nucleotides are also a biomaterial like the target material, the probe material, and a reagent, physical, chemical, biological, and/or biochemical reactions other than the bindings between the target material and the probe material may be inhibited by controlling biological and/or biochemical reaction conditions in a biocompatible manner in assays using a microarray. Thus, in a biological sample assay, the binding between the probe material contained in the spot region and the target material may be promoted by the layer 200 including DNA molecules, each including 2 to 6 nucleotides, at a temperature greater than about 19° C.

Referring to FIG. 1, the spot region 300 and the layer 200 including the DNA molecules are formed on the substrate 100. The substrate 100 may be formed of a material to which a probe material which binds to a target material may bind. In this regard, the substrate 100 may be formed of, but is not limited to, a material selected from a group consisting of silicon, glass, metal, plastic, and ceramic. If the substrate 100 is formed of silicon, a silicon dioxide (SiO₂) layer may be formed on the substrate 100 so that the probe material binds to the substrate 100. The surface of the substrate 100 may be treated with a material selected from a group consisting of, but not limited to, a linker, an amine group, a carboxyl group, an epoxy group, a sulfur group, an aldehyde group, activated ester, maleimide, and carbohydrate in order to bind to the probe material contained in the spot region 300 and the DNA molecules contained in the layer 200.

Referring to FIG. 1, the substrate 100 has a planar shape, but the substrate 100 may also be in the form of a bead or a sphere. However, the substrate 100 is not limited to these structures.

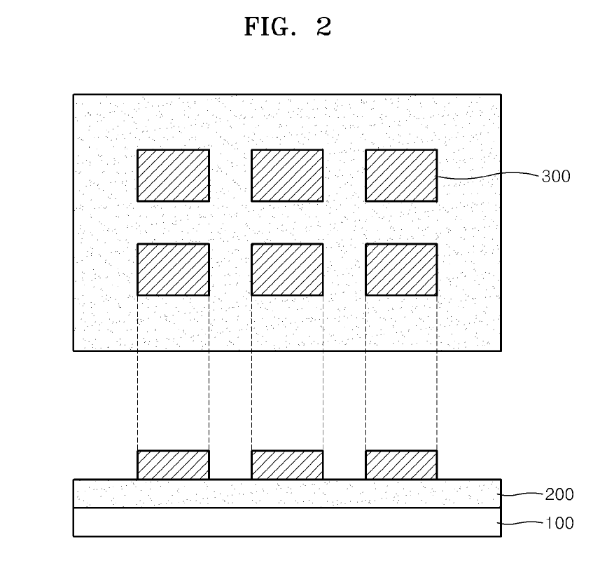

FIG. 2 is a schematic diagram illustrating an exemplary embodiment of a microarray including, the microarray comprising: a layer 200 formed on a substrate 100, wherein the layer includes DNA molecules, each including at least two nucleotides, and a spot region 300 and formed on the layer 200, wherein the spot region includes a probe material.

Referring to FIG. 2, the layer 200 is formed on the substrate 100. In one aspect, DNA molecules, each including at least two nucleotides, are immobilized on the substrate forming the layer 200. The spot region 300 is formed on the layer 200. In one aspect, a probe material capable of binding to a target material is immobilized on the surface of the substrate 100, forming spot region 300. The probe material may bind to the DNA molecules contained in the layer 200 directly or via a linker. The DNA molecules contained in the layer 200 may function as a linker between the probe material contained in the spot region 300 and the substrate 100.

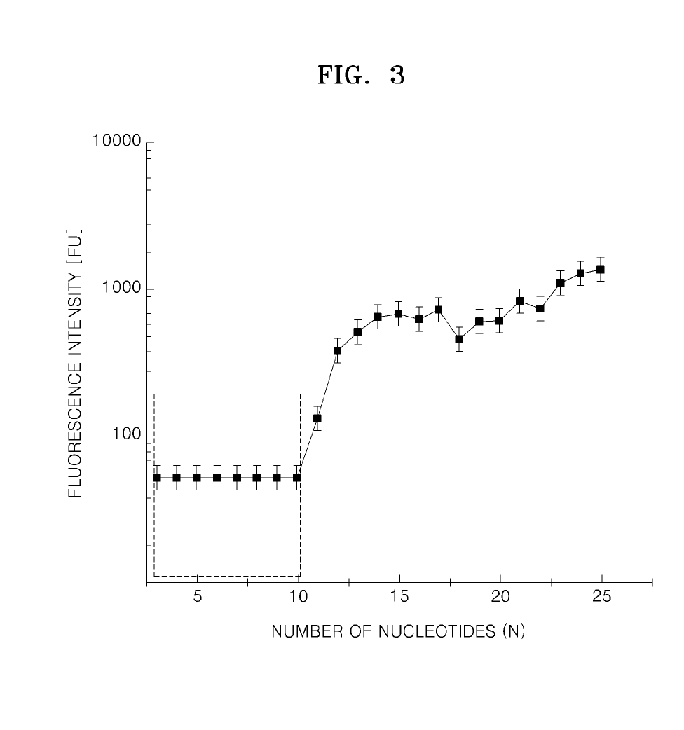

FIG. 3 is a graph illustrating the degree of hybridization according to the number of nucleotides contained in DNA molecules.

In order to identify the degree of hybridization of DNA molecules according to the number of nucleotides, a target material, a quality control “QC” oligo 1 (SEQ ID NO. 1: 5′ TTCCAGGGCGCGAGTTGATAGCTGG-biotin 3′) including 3′-biotin, to which a fluorophore binds in a subsequent process, is treated with single-stranded DNA molecules, each including 1 to 25 nucleotides, at 45° at 100 pM, and fluorescence emitted by the binding of the target material to the DNA molecules is measured. The results are shown in FIG. 3. Fluorescent signals are detected using a scanning device, and the detected fluorescent signals are processed to form image data with various colors using a graphic interface. According to the results, a single-stranded DNA molecule including 1 to 10 nucleotides has a fluorescence intensity of about 60 FU, which is maintained within an error range. On the other hand, a single-stranded DNA molecule including more than 10 nucleotides has a fluorescence intensity in a range of about 150 to about 1100 FU. According to the results, the single-stranded DNA molecule including more than 10 nucleotides is actively hybridized to the target material, while the single-stranded DNA molecule including 1 to 10 nucleotides is relatively less actively hybridized to the target material.

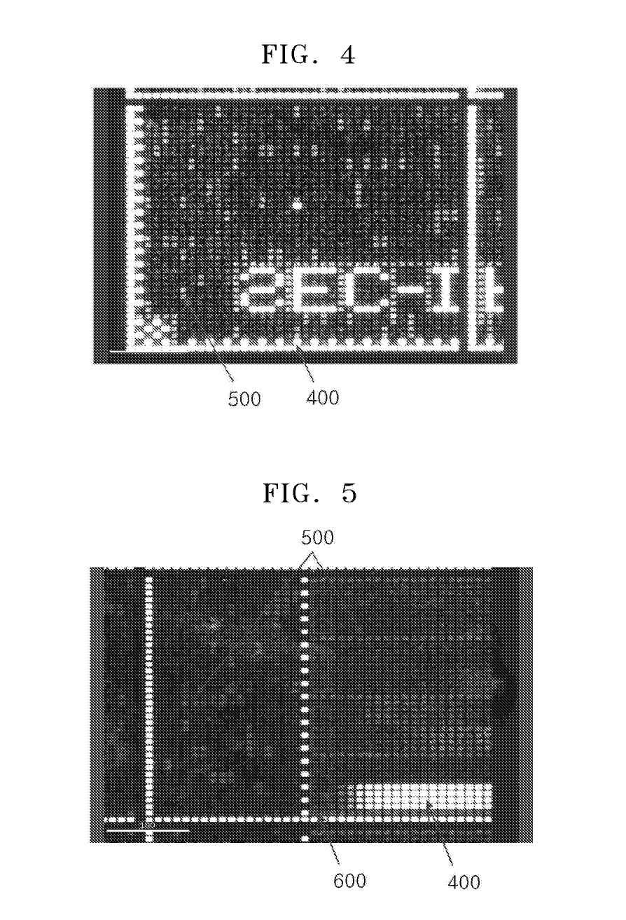

FIG. 4 is an image illustrating fluorescence emission measured by contacting a microarray including a spot region 400 and a layer 500 including hexa-ethylene glycol with a target material.

Referring to FIG. 4, the microarray includes the spot region 400 and the layer 500. The spot region 400 was formed by immobilizing a probe material capable of binding to the target material to specified regions of the substrate. Referring to FIG. 4, the probe material capable of binding to the target material is a DNA oligomer (SEQ ID NO. 2: 5′ CCAGCTATCAACTCGCGCCCTGGAA 3′). The base sequence of the target material (SEQ ID NO. 2) has a base sequence that is complementary to the base sequence of the probe material (SEQ ID NO. 2). The layer 500 was formed by immobilizing hexa-ethylene glycol to the substrate at specified regions.

Referring to FIG. 4, a target material was mixed with the microarray including the spot region 400 and the layer 500. The target material is a QC oligo 1 (SEQ ID NO. 1: 5′ TTCCAGGGCGCGAGTTGATAGCTGG-biotin 3′) that is complementary to the probe material and binds to biotin to which a fluorophore is attached. As demonstrated by FIG. 4, the spot region 400 exhibits strong fluorescence intensity. However, the layer 500 including hexa-ethylene glycol exhibits detectable fluorescence intensity but less than that of the spot region 400. Detection sensitivity may be reduced by fluorescence emission detected in regions other than the spot region 400, for example, the layer 500.

FIG. 5 is an image illustrating fluorescence emission measured by contacting a microarray including a spot region 400, a layer 500 including hexa-ethylene glycol, and a layer 600 including DNA molecules, each including 6 nucleotides, with a target material.

Referring to FIG. 5, the microarray includes the spot region 400 including a probe material which may bind to the target material, the layer 500 including hexa-ethylene glycol, and the layer 600 including DNA molecules, each including 6 nucleotides, which may bind to the target material. The spot region 400 was formed by immobilizing a probe material capable of binding to the target material to specified regions of the substrate. Referring to FIG. 4, the probe material capable of binding to the target material is a DNA oligomer (SEQ ID NO. 2: 5′ CCAGCTATCAACTCGCGCCCTGGAA 3′). The layer 500 was formed by immobilizing hexa-ethylene glycol to the substrate at specified regions. The layer 600 was formed by immobilizing DNA molecules, each including 6 nucleotides, to the substrate at specified regions.

With regard to FIG. 5, a target material was mixed with the microarray including the spot region 400, the layer 500 including hexa-ethylene glycol, and the layer 600. The target material is a QC oligo 1 (SEQ ID NO. 2: 5′ TTCCAGGGCGCGAGTTGATAGCTGG-biotin 3′) that is complementary to the probe material and binds to biotin to which a fluorophore is attached. As demonstrated by FIG. 5, the spot region 400 exhibits strong fluorescence intensity. However, the layer 500 including hexa-ethylene glycol exhibits detectable fluorescence intensity but less than that of the spot region 400. Meanwhile, the layer 600 including DNA molecules, each including 6 nucleotides, exhibits less fluorescence intensity than that of the spot region 400 and the layer 500 including hexa-ethylene glycol. Thus, when compared with the results of FIG. 4, the target material may be detected more efficiently by forming the layer 600 including DNA molecules, each including at least 2, for example, 2 to 6 nucleotides, on a region of the microarray other than where the spot region 400 is formed.

As described above, the microarray according to the one or more of the above embodiments has excellent sensitivity for detecting target materials during biological assays. Furthermore, using the method described above, a microarray with excellent sensitivity for detecting target materials during biological assays may be manufactured.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A microarray comprising:
a substrate;
a spot region formed on the substrate, wherein the spot region comprises a probe material capable of binding to a target material; and
a layer formed on a region of the substrate other than where the spot region is formed, wherein the layer comprises DNA molecules, each comprising at least two nucleotides.

2. A microarray comprising:
a substrate;
a layer formed on the substrate wherein the layer comprises DNA molecules, each comprising at least two nucleotides; and
a spot region formed on the layer, wherein the spot region comprises a probe material capable of binding to a target material.

3. The microarray of claim 1, wherein the binding of the probe material to the target material is performed at a temperature greater than about 19° C.

4. The microarray of claim 1, wherein the probe material comprises one selected from a group consisting of DNA, RNA, nucleotide, nucleoside, protein, polypeptide, peptide, amino acid, carbohydrate, enzyme, antibody, antigen, receptor, virus, substrate, ligand, membrane, and the like and a combination comprising at least one of the foregoing probe materials.

5. The microarray of claim 1, wherein the nucleotide comprises a base selected from a group consisting of adenine, guanine, thymine, and cytosine.

6. The microarray of claim 1, wherein the DNA molecules comprise 2 to 6 nucleotides.

7. The microarray of claim 1, wherein the substrate is in the form of a plane, a bead, or a sphere.

8. The microarray of claim 1, wherein the substrate is selected from a group consisting of silicon, glass, metal, plastic, and ceramic.

9. A method of manufacturing a microarray, the method comprising:
preparing a substrate;
forming a spot regions on the substrate, wherein the spot region comprises a probe material capable of binding to a target material; and
forming a layer on a region of the substrate other than where the spot region is formed, wherein the layer comprises DNA molecules, each comprising at least two nucleotides.

10. A method of manufacturing a microarray, the method comprising:
preparing a substrate;
forming a layer on the substrate, wherein the layer comprises DNA molecules, each comprising at least two nucleotides; and
forming a spot region on the layer, wherein the spot region comprises a probe material capable of binding to a target material on the layer.

11. The method of claim 9, wherein the substrate is in the form of a plane, a bead, or a sphere.

12. The method of claim 9, wherein the substrate is selected from a group consisting of silicon, glass, metal, plastic, and ceramic.

13. The method of claim 9, wherein the nucleotide comprises a base selected from a group consisting of adenine, guanine, thymine, and cytosine.

14. The method of claim 9, wherein each of the DNA molecules comprises 2 to 6 nucleotides.

15. The method of claim 9, wherein the probe material comprises one selected from a group consisting of DNA, RNA, nucleotide, nucleoside, protein, polypeptide, peptide, amino acid, carbohydrate, enzyme, antibody, antigen, receptor, virus, substrate, ligand, membrane, and the like and a combination comprising at least one of the foregoing probe materials.

16. The microarray of claim 2, wherein the binding of the probe material to the target material is performed at a temperature greater than about 19° C.

17. The microarray of claim 2, wherein the probe material comprises one selected from a group consisting of DNA, RNA, nucleotide, nucleoside, protein, polypeptide, peptide, amino acid, carbohydrate, enzyme, antibody, antigen, receptor, virus, substrate, ligand, membrane, and the like and a combination comprising at least one of the foregoing probe materials.

18. The microarray of claim 2, wherein the nucleotide comprises a base selected from a group consisting of adenine, guanine, thymine, and cytosine.

19. The microarray of claim 2, wherein the DNA molecules comprise 2 to 6 nucleotides.

20. The microarray of claim 2, wherein the substrate is in the form of a plane, a bead, or a sphere.

21. The microarray of claim 2, wherein the substrate is selected from a group consisting of silicon, glass, metal, plastic, and ceramic.

22. The method of claim 10, wherein the substrate is in the form of a plane, a bead, or a sphere.

23. The method of claim 10, wherein the substrate is selected from a group consisting of silicon, glass, metal, plastic, and ceramic.

24. The method of claim 10, wherein the nucleotide comprises a base selected from a group consisting of adenine, guanine, thymine, and cytosine.

25. The method of claim 10, wherein each of the DNA molecules comprises 2 to 6 nucleotides.

26. The method of claim 10, wherein the probe material comprises one selected from a group consisting of DNA, RNA, nucleotide, nucleoside, protein, polypeptide, peptide, amino acid, carbohydrate, enzyme, antibody, antigen, receptor, virus, substrate, ligand, membrane, and the like and a combination comprising at least one of the foregoing probe materials.
